(19) United States
(12) Patent Application Publication
(10) Pub. No.: US 2017/0055451 A1
(43) Pub. Date: Mar. 2, 2017

(54) CAM TRACK TIMING ADJUSTMENT FOR A PICK-UP REEL OF A HARVESTER

(71) Applicant: HCC, Inc., Mendota, IL (US)

(72) Inventor: Edward Patrick Jasper, Mendota, IL (US)

(21) Appl. No.: 15/249,584

(22) Filed: Aug. 29, 2016

Related U.S. Application Data
(60) Provisional application No. 62/213,296, filed on Sep. 2, 2015.

(51) Int. Cl. A01D 57/12

(52) U.S. Cl. CPC A01D 57/12

(57) ABSTRACT

A cam track adjustment mechanism for use with the pick-up reel of a harvester. A cam track is provided which is rotatably adjustable about an axis which is spaced away from the fixed axis of rotation of the pick-up reel. The two axes may be generally horizontally aligned relative to each other. Preferably, the cam track is rotatable around a point away from the fixed reel axis and generally on the horizontal plane of the rotational path, and is positioned so an arc from it to the entry and exit cam path is generally concentric. As such, tine angularity is less effected in these areas as a result of adjusting the cam track. With this type of timing or pitch adjustment, tine angularity can be changed in the crop gathering portion of the rotational path with minimized effect in the crop entry and exit portions of the rotational path.

### RELATED APPLICATION (PRIORITY CLAIM)

This application claims the benefit of United States Provisional Application Ser. No. 62/213,296, filed Sep. 2, 2015, which is hereby incorporated herein by reference in its entirety.

### BACKGROUND

The present invention generally relates to harvester pick up reels, and more specifically relates to harvester pick-up reels which include cam tracks that are adjustable.

A typical harvester includes a pick-up reel. The pick-up reel includes a center support tube, which effectively defines the longitudinal axis of the pick-up reel. Rotation of the pick-up reel occurs around this axis during operation. A typical pick-up reel also includes a plurality of bat tubes which are parallel to the center support tube, as well as tines which are arranged along each of the bat tubes. When the harvester operates, the pick-up reel rotates, causing the tines to engage the crop and pull the crop into the harvester.

Some pick-up reels have tine paths that do not rotate in a circle, but instead have tine paths which rotate in a pre-defined non-circular path where the path is defined by a cam track which is proximate one or both ends of the pick-up reel. Some pick-up reels have cam tracks that are adjustable in terms of their pitch or timing. To adjust the cam track, the cam track is disconnected from the pick-up reel, rotated in a circular fashion about the axis of the center support tube thereby changing the angularity of the cam track to the fixed reel axis. Then, the cam track is re-connected. In this manner, the pitch or angularity of the tines change equally through the full perimeter of the pick-up reel's rotational path. However, it would be more preferable to limit change in the tine angularity in the crop entry and exit portions (i.e., horizontal components of the rotational path of the pick-up reel), while having the most change in tine angularity in the crop gathering portion (i.e., a vertical component of the rotational path of the pick-up reel).

### SUMMARY

An object of an embodiment of the present invention is to provide an improved cam track timing adjustment mechanism for a harvester pick-up reel.

Another object of an embodiment of the present invention is to provide a cam track timing adjustment mechanism where, as a result of adjusting the cam track, tine angularity in the crop entry and exit portions (i.e., horizontal components of the rotational path of the pick-up reel) is changed less than tine angularity in the crop gathering portion (i.e., a vertical component of the rotational path of the pick-up reel).

Briefly, an embodiment of the present invention provides a cam track adjustment mechanism for use with the pick-up reel of a harvester. While the pick-up reel rotates about a fixed reel axis during operation, the cam track is rotatably adjustable about a different axis which is spaced from the fixed reel axis. The two axes may be generally horizontally aligned relative to each other. Preferably, the cam track is rotatable around a point away from the fixed reel axis and generally on the horizontal plane of the rotational path, and is positioned so an arc from it to the entry and exit cam path is generally concentric. As such, tine angularity is less affected in these areas as a result of adjusting the cam track. With this type of timing or pitch adjustment, tine angularity can be changed in the crop gathering portion of the rotational path with minimized effect in the crop entry and exit portions of the rotational path.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a side view of a conventional harvester, which includes a pick-up reel; and

FIG. 2 illustrates a cam track adjustment mechanism which is in accordance with an embodiment of the present invention;

FIG. 3 is similar to FIG. 2, but identifies the three (3) different crop areas of the pick-up reel, identifies the adjustment arc of the cam track, and identifies the cam path.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

An embodiment of the present invention provides a tubular bat shape for use with a harvester pick-up reel, where the tubular bat shape is configured to resist torsional loads as well as provide for variance in tine spacing along the bat tube.

First, a conventional harvester which includes bat tubes will be generally described, and then a tubular bat shape (and a preferred bat tube system), which is in accordance with an embodiment of the present invention will be described.

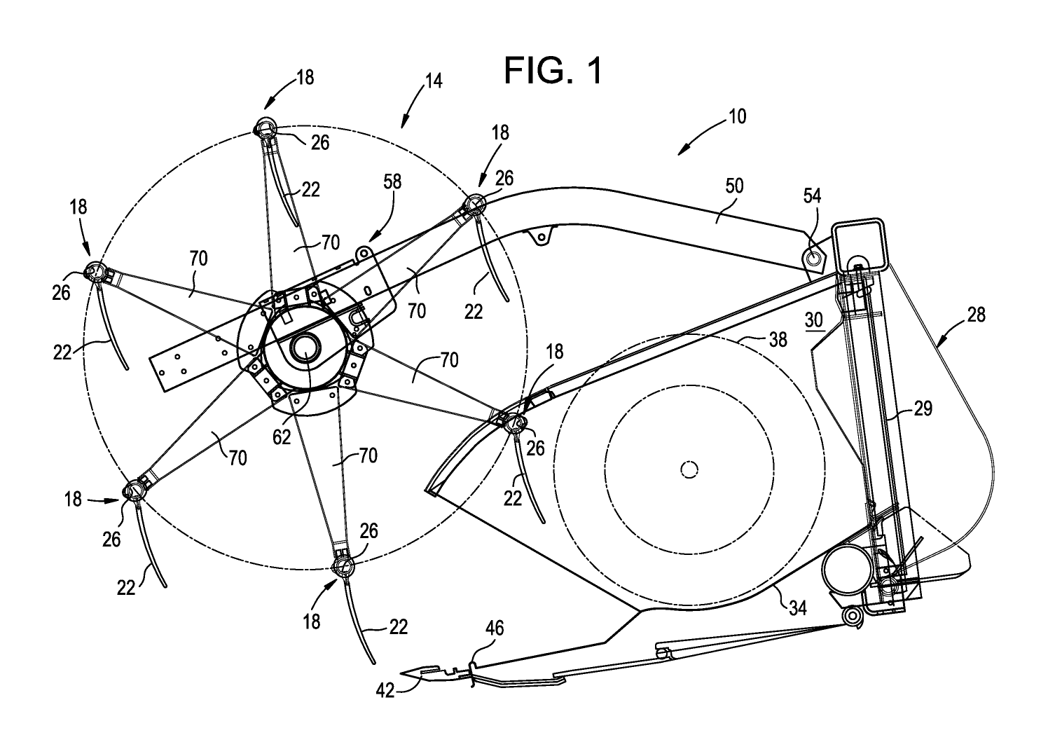

FIG. 1 is a side view of a conventional harvester 10 utilizing a pick-up reel 14. The harvester 10 shown in FIG. 1 includes a non-flip reel, i.e., a pick-up reel 14 that provides for standard tine action (i.e., that the tines 22 do not flip during harvesting), but embodiments of the present invention can be utilized with flip-type reels as well.

The harvester 10 includes the pick-up reel 14, and a harvester tine and bat tube assembly 18. The assembly 18 includes harvester tines 22 and bat tubes 26. The harvester 10 also includes a harvester platform 28 including a platform frame 29, supported for movement over ground, and side and rear wall 30. A floor 34 extends between the opposite side walls 30, and a transverse crop converging auger 38 is rotatably supported above the floor 34 and forward of the rear wall 30 (unless the harvester is provided as being a draper header type of harvester, in which case cross belts would be utilized instead of an auger). A transverse cutter bar 42 is mounted along the forward edge of the floor 34, and an upright crop dam 46 is supported between the cutter bar 42 and the floor 34.

The pick-up reel 14 generally spans the width of the platform 28, forward of the auger 38 and above the cutter bar 42. The pick-up reel 14 is connected to the platform 28 by a pair of reel support arms 50 (one shown), which support the pick-up reel 14 on the frame 29. In the construction illustrated in FIG. 1, the support arms 50 are pivotally connected to the frame 29 at pivot points 54. The support arms 50 are generally above the sidewalls 30 of the platform 28. Preferably, the support arms 50 are selectively vertically adjustable by a pair of cylinders (not shown) connected between the support arms 50 and the sidewalls 30.

A movable support structure 58 is supported at the forward end of each support arm 50. The support structures 58 are generally slidable between forward and rearward positions on the support arm 50, and their movement is controlled by a pair of cylinders (not shown). The support arms 50 and the support structures 58 are adjustably positioned to adjust the position of the pick-up reel 14 relative to the platform 28.

A tubular reel shaft or first shaft 62 is journalled by and extends between the support structures 58. The first shaft 62 is rotatable relative to the support structures 58 about its axis, and a plurality of arms 70 (six in the illustrated construction) radially extend from the shaft 62.

Bat tubes 26 are journalled in the outer ends of the arms 70. The bat tubes 26 are rotatable with the associated arms 70 and, in the illustrated construction, are rotatable relative to the associated arms 70. The bat tubes 26 span the width of the pick-up reel 14 and are generally parallel to and radially-spaced from the first shaft 62. A plurality of harvester tines 22 are connected to each bat tube 26 for movement with the bat tube 26 (in the illustrated construction, for rotation relative to the first shaft 62 and relative to the associated arms 70).

The above description regarding FIG. 1 was merely provided to explain one possible environment in which the present invention may exist, and should not be considered to be limiting in any way, as the present invention can be employed with pick-up reels and harvesters that are very different from that which is illustrated in FIG. 1.

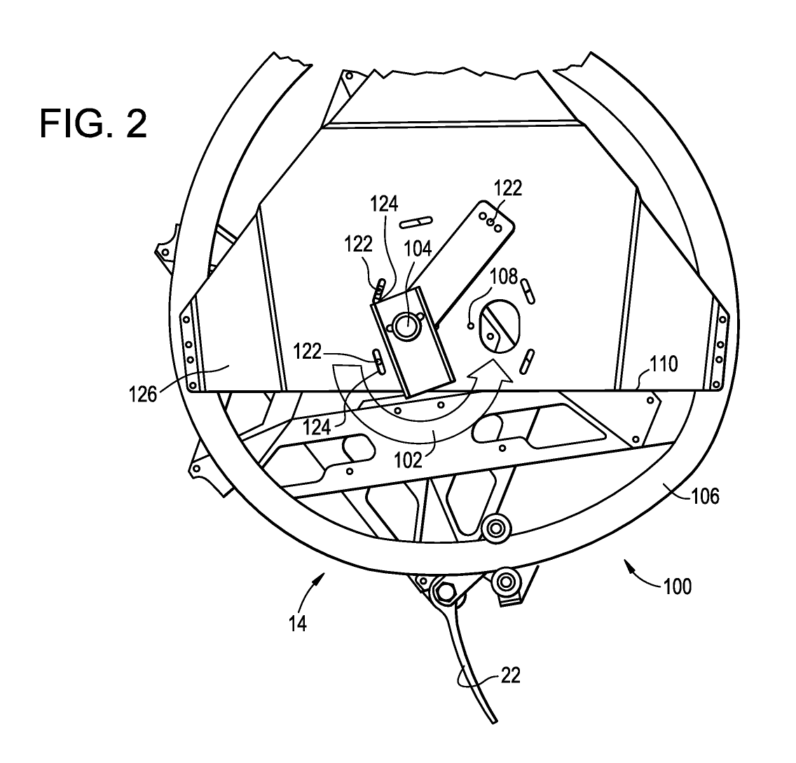

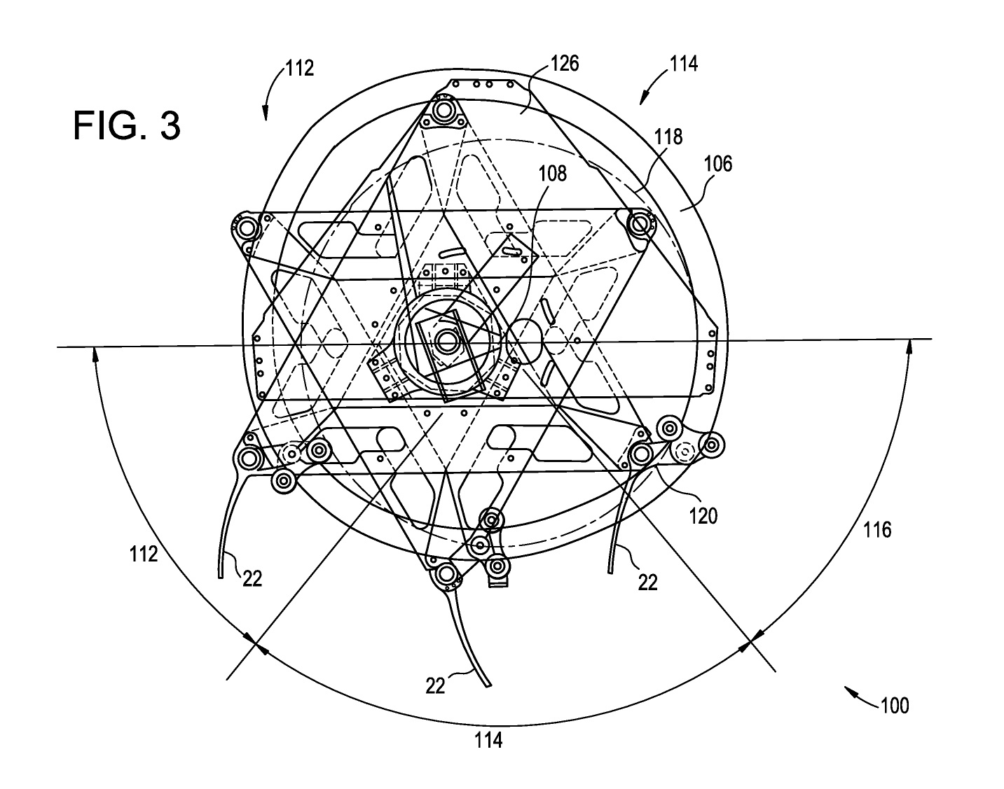

FIGS. 2 and 3 illustrate a cam track adjustment mechanism 100 which is in accordance with an embodiment of the present invention. The cam track adjustment mechanism 100 is configured for use with a pick-up reel and harvester, like the pick-up reel 14 and harvester 10 shown in FIG. 1, for example. While the pick-up reel 14 rotates (said rotation being indicated with arrow 102 in FIG. 2) about a fixed axis 104 during operation, the cam track 106 is rotatably adjustable about a different axis 108 which is spaced from the fixed reel axis 104. The two axes 104, 108 may be generally horizontally aligned relative to each other, along a horizontal plane 110. Preferably, the cam track 106 is rotatable around a point 108 away from the fixed reel axis 104 and generally on the horizontal plane 110 of the rotational path, and is positioned so an arc from it to the entry and exit cam path is generally concentric. As such, tine angularity is less affected in these areas as a result of adjusting the cam track. With this type of timing or pitch adjustment, tine angularity can be changed in the crop gathering portion of the rotational path with minimized effect in the crop entry and exit portions of the rotational path.

While FIGS. 2 and 3 show the preferred configuration, wherein the axis of rotation 108 of the cam track 106 is closer to the header than the fixed axis 104 of rotation of the pick-up reel 14, the axis 108 of rotation of the cam track 106 can be provided as being further away from the header than the fixed axis 104 of rotation of the pick-up reel 14.

FIG. 3 identifies the three (3) different crop areas of the pick-up reel—the crop entry area 112, the crop gathering area 114, and the crop exit area 116. FIG. 3 also identifies the adjustment arc 118 of the cam track 106, identifies the cam path 120, and indicates how mismatched the arc 118 from the adjustment axis 108 and the cam path 120 are in the crop gathering area 114. As a result, adjusting the cam track 106 will have greater effect on the pitch of the tines 22 in the crop gathering area 114. FIG. 3 also indicates how the arc 118 from the adjustment axis 108 closely follows the cam path 120 in the crop exit area 116. As a result, adjusting the cam track 106 will have very little effect on the pitch of the tines 22 in the crop exit area 116 (and the crop entry area 112 as well).

With regard to adjustment of the cam track 106, this can be accomplished by loosening a plurality of bolts 122 which bolt the cam track 106 to the pick up reel, and pivoting the cam track 106 such that the bolts 112 pivot in corresponding slots 124, which can be provided on a plate 126, which is attached to the cam track 106. Still other ways of adjusting the angular position of the cam track 106 can be provided.

Regardless, an embodiment of the present invention provides a cam track adjustment mechanism which provides that the angular position of the cam track relative to the pick-up reel can be adjusted, and the adjustment provides for greater effect on the pitch of the tines in the crop gathering area than the pitch of the tines in the crop entry and exit areas. To accomplish this, the cam track can be provided as having an axis of rotation which is offset from the fixed axis of rotation of the pick-up reel. Preferably, the two axes are aligned on a horizontal plane, and the cam track is relatively easy to adjust.

While a specific embodiment of the invention has been shown and described, it is envisioned that those skilled in the art may devise various modifications without departing from the spirit and scope of the present invention.

What is claimed is:

1. A cam track adjustment mechanism for use with the pick-up reel of a harvester, wherein the pick-up reel is configured to rotate about a first axis during operation, wherein the cam track adjustment mechanism comprises a cam track which is configured to be rotatably adjustable about a second axis which is spaced from the first axis.

2. The cam track adjustment mechanism of claim 1, wherein the first and second axes are horizontally aligned relative to each other.

3. The cam track adjustment mechanism of claim 1, wherein the cam track adjustment mechanism is configured such that the cam track is rotatable around a point which is spaced away from the first axis and which is generally on a horizontal plane of a rotational path of the pick-up reel.

4. The cam track adjustment mechanism of claim 1, wherein the cam track is configured such that the cam track is positioned so an arc from the cam track to an entry and exit cam path is generally concentric.

5. The cam track adjustment mechanism of claim 1, further comprising a plate which is attached to the cam track, and plurality of fasteners which fasten the plate to the pick up reel.

6. The cam track adjustment mechanism of claim 5, wherein the cam track adjustment mechanism is configured such that adjustment of the cam track is accomplishable by loosening the plurality of fasteners which fasten the plate to the pick up reel, and pivoting the cam track such that the fasteners pivot in the slots in the plate which is attached to the cam track.

7. The cam track adjustment mechanism of claim 5, wherein the fasteners are bolts.

8. The cam track adjustment mechanism of claim 1, wherein the first and second axes are horizontally aligned relative to each other, wherein the cam track adjustment mechanism is configured such that the cam track is rotatable around a point which is spaced away from the first axis and which is generally on a horizontal plane of a rotational path of the pick-up reel.

9. The cam track adjustment mechanism of claim 8, wherein the cam track is configured such that the cam track is positioned so an arc from the cam track to an entry and exit cam path is generally concentric.

10. The cam track adjustment mechanism of claim 1, further comprising a plate which is attached to the cam track, and plurality of fasteners which fasten the plate to the pick up reel, wherein adjustment of the cam track is accomplishable by loosening the plurality of fasteners which fasten the plate to the pick up reel, and pivoting the cam track such that the fasteners pivot in the slots in the plate which is attached to the cam track.

11. The cam track adjustment mechanism of claim 10, wherein the fasteners are bolts.

12. The cam track adjustment mechanism of claim 10, wherein the cam track adjustment mechanism is configured such that the cam track is rotatable around a point which is spaced away from the first axis and which is generally on a horizontal plane of a rotational path of the pick-up reel.

13. The cam track adjustment mechanism of claim 10, wherein the cam track is configured such that the cam track is positioned so an arc from the cam track to an entry and exit cam path is generally concentric.

14. The cam track adjustment mechanism of claim 1, wherein an arc from an adjustment axis and a cam path in a crop gathering area are mismatched, wherein adjusting the cam track has an enhanced effect on a pitch of tines of the pick-up reel in the crop gathering area.

15. The cam track adjustment mechanism of claim 1, wherein the first and second axes are horizontally aligned relative to each other, wherein the cam track adjustment mechanism is configured such that the cam track is rotatable around a point which is spaced away from the first axis and which is generally on a horizontal plane of a rotational path of the pick-up reel, wherein the cam track is configured such that the cam track is positioned so an arc from the cam track to an entry and exit cam path is generally concentric, further comprising a plate which is attached to the cam track, and plurality of fasteners which fasten the plate to the pick up reel, wherein the cam track adjustment mechanism is configured such that adjustment of the cam track is accomplishable by loosening the plurality of fasteners which fasten the plate to the pick up reel, and pivoting the cam track such that the fasteners pivot in the slots in the plate which is attached to the cam track, wherein the cam track adjustment mechanism is configured such that the cam track is rotatable around a point which is spaced away from the first axis and which is generally on a horizontal plane of a rotational path of the pick-up reel, wherein an arc from an adjustment axis and a cam path in a crop gathering area are mismatched, wherein adjusting the cam track has an enhanced effect on a pitch of tines of the pick-up reel in the crop gathering area.
